(19) United States
(12) Patent Application Publication
(10) Pub. No.: US 2021/0363036 A1
(43) Pub. Date: Nov. 25, 2021

(54) Method for decontaminating an aqueous liquid medium containing micropollutants or a surface contaminated with micropollutants

(71) Applicants: UNIVERSITE DE BORDEAUX, BORDEAUX (FR); INSTITUT NATIONAL DE LA SANTE ET DE LA RECHERCHE MEDICALE (INSERM), PARIS (FR); CENTRE NATIONAL DE LA RECHERCHE SCIENTIFIQUE (CNRS), PARIS (FR); CENTRE HOSPITALIER UNIVERSITAIRE DE BORDEAUX, TALENCE CEDEX (FR)

(72) Inventors: Philippe BARTHELEMY, MERIGNAC (FR); Sylvie CRAUSTE-MANCIET, BORDEAUX (FR); Marc SICARD, PAREMPUYRE (FR)

(21) Appl. No.: 16/970,891

(22) PCT Filed: Feb. 22, 2019
(86) PCT No.: PCT/FR2019/050419

§ 371 Date: Aug. 18, 2020

(30) Foreign Application Priority Data
Feb. 22, 2018 (FR) 1851548
Mar. 23, 2018 (FR) 1852544

(51) Int. Cl. C02F 1/68; A01N 43/54

(52) U.S. Cl. CPC C02F 1/683; C02F 2101/30; A01N 43/54

(57) ABSTRACT

The invention relates to a method for decontaminating an aqueous liquid medium containing molecular micropollutants or a surface contaminated with micropollutants using nucleolipid compounds.

The invention relates to a method for decontaminating an aqueous liquid medium containing molecular micropollutants or a surface contaminated with micropollutants, using nucleolipid compounds.

In particular, the invention relates to a method for the treatment of an aqueous liquid medium or a surface making it possible to remove from said medium or said surface the molecular micropollutants that are present there, in particular those originating from metabolized medicaments.

Human activities, whether domestic, commercial or industrial, release into water pollutants such as organic matter, pesticides, detergents, hydrocarbons, medicaments, etc.

These chemical wastes alter and degrade the quality of the water.

The concentrations of pollutants in seawater depend on the compound, but are generally of the order of nanograms or micrograms per litre. Thus these are known as micropollutants, i.e., for example, anthropic or natural substances having different origins (pharmaceutical products, healthcare products, industrial chemical products, etc.) present in the waters at concentrations in particular of the order of ng/L to μg/L (Y. Luo et al., Science of the Total Environment, 2014, 473-474, 619-641).

For example, after metabolization in the human organism, medicaments are disposed of in the sewerage systems in their initial form or in the form of metabolites (B. Hailing-Sorensen, Chemosphere, 1998, 36, 357-393), then treated in wastewater treatment plants.

However, the micropollutants are only partially degraded, and generate degradation products which may have a greater toxicity than that of the original medicaments. (M. Isidori et al., Sci Total Environ, 2005, 348, 93-101). Thus, studies have shown that different medicaments, in particular Diclofenac® (non-steroidal anti-inflammatory) and Propranolol® (beta-blocker), widely-used medicaments, are found in different environmental aqueous media or those used for consumption (R. Rosal et al., Water Res., 2010, 44, 578-588), in particular drinking water.

In addition, even if the concentration of each micropollutant in the aqueous medium may not reach a toxic level, the cumulative combination of different micropollutants can reach toxicity levels that are considerably higher (R. Renner et al., Environ Sci Technol, 2002, 36, 268A-269A), and affect all types of living organisms.

Similarly, in a hospital environment (pharmacy or healthcare services), in particular veterinary or pharmacy, there are a certain number of surfaces that are regularly in contact with micropollutants, in particular originating from pharmaceutical products. These surfaces become potential sources of exposure to these micropollutants.

Decontamination of a liquid medium containing micropollutants, in particular an aqueous liquid medium, or a surface contaminated by such micropollutants therefore represents a public health challenge.

This problem arises crucially with respect to the micropollutants originating from medicaments, as the latter are highly soluble in water.

The existing filtration solutions do not give totally satisfactory results (Y. Luo et al., Science of the Total Environment, 2014, 473-474, 619-641).

It has now been found possible to use nucleolipid compounds for decontaminating an aqueous liquid medium containing micropollutants, said micropollutants being in the form of molecules in solution in said medium, or a surface contaminated by such micropollutants.

The invention is however not limited to aqueous liquid mediums and can be applied to non-aqueous liquid mediums.

Amphiphilic nucleotide compounds, also called nucleolipids or nucleolipid compounds, are biocompatible compounds constituted by a lipid covalently linked to a nucleotide. They are non-toxic, biodegradable, and have demonstrated their beneficial properties in the fields of biocompatible gels or medical imaging, or also in nanoparticular formulations that are useful as drug vectors.

In the present description, the terms “nucleolipids” and “nucleolipid compounds” will be used interchangeably.

For example, patent applications WO2009/098404 and WO2010/136676 relate to the preparation and the uses of such compounds for the transport or vectorization of therapeutic agents.

Patent application WO2016/170010 relates to non-polymeric nano-formulations based on lipids, loaded with metal particles and a therapeutic agent, as agents for the transport, vectorization, intra-cellular delivery, cellular targeting or cellular localization of said therapeutic agent.

Patent application WO2013/110902 describes a method for the decontamination of a liquid medium containing particles by hydrogels formed from nucleolipids and/or an organic compound originating from a living organism (jellyfish).

As indicated on p. 4, I.30 to I.5-16 of this application, said particles are defined as being an aggregate resulting from the association of organic and/or inorganic molecules, having no molecular mass, and excluding the molecules in solution. This application also defines the term “nanopartide” as a particle of nanometric size, said nanoparticle being an assembly of molecules of which at least one dimension is situated at nanometric scale, or also a particle of which the nominal diameter is less than 100 nm, preferably comprised between 0.5 nm and 100 nm.

WO2013/110902 cites in particular by way of example of particles or nanoparticles the fluorescent semiconductor nanocrystals (or “quantum dots” (“QDs”)), or the gold nanoparticles (AuNPs), which are inorganic compounds of nanometric size.

Example 1 of WO2013/110902 describes the decontamination of an aqueous suspension of micelles containing QDs by a hydrogel formed from amphiphilic glycosyl-nucleosyl-fluorinated compounds (GNFs). Example 2 describes the decontamination of a solution containing gold particles (AuNPs) by a hydrogel formed from GNFs. The examples of WO2013/110902 thus do not describe the decontamination of an aqueous liquid medium containing micropollutants in molecular form.

The invention therefore relates to a method for decontaminating an aqueous liquid medium containing at least one micropollutant in molecular form, or a surface contaminated with a micropollutant, comprising
a step of contacting said aqueous liquid medium containing at least one micropollutant in molecular form or said surface contaminated with a micropollutant with at least one nucleolipid compound of formula (I)

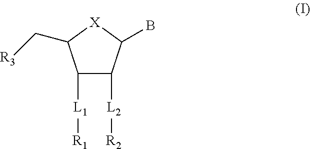

in which
X is an oxygen atom, sulfur or a methylene group
B represents a purine or pyramidic base, or also a non-natural heterocyclic mono- or bicyclic base, each ring of which comprises 4 to 7 members, optionally substituted;
L₁ and L₂, identical or different, represent hydrogen, an —O—C(O)— oxycarbonyl group, an —O—C(S)—NH— thiocarbamate group, an —O—C(O)—O-carbonate group, an —O—C(O)—NH— carbamate group, an oxygen atom, a phosphate group, a phosphonate group or a heteroaryl group comprising from 1 to 4 nitrogen atoms, substituted or unsubstituted by a saturated or unsaturated, linear or branched C₈-C₃₀ hydrocarbon chain;
where L₁ represents a phosphate or phosphonate group and L₂ represents hydrogen;
or also, L₁ and L₂ together form a ketal group of formula

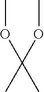

or also L₁ or L₂ represents hydrogen, and the other one represents a hydroxy group or a heteroaryl group comprising 1 to 4 nitrogen atoms, unsubstituted or substituted by a linear or branched C₈-C₃₀ alkyl chain;
R₁ and R₂, identical or different, represent
a linear or branched C₈-C₃₀ hydrocarbon chain, saturated or comprising one or more unsaturations,
a C₈-C₃₀ acyl chain,
a diacyl chain in which each acyl chain is C₈-C₃₀,
a diacylglycerol chain in which each acyl chain is C₈-C₃₀,
a sphingosine or ceramide group, or
when L₁ or L₂ represents hydrogen, and the other represents a hydroxy group or a heteroaryl group comprising 1 to 4 nitrogen atoms, R₁ and R₂ are not present;
R₃ represents:
a hydroxy, amino, phosphate, phosphonate, phosphatidylcholine, O-alkyl phosphatidylcholine, thiophosphate, phosphonium, NH₂—R₄, NHR₄R₅ or NR₄R₅R₆ group in which R₄, R₅ and R₆, identical or different, represent a hydrogen atom or a linear or branched C₁-C₆ alkyl or linear or branched C₁-C₆ hydroxyalkyl chain, or
a linear or branched C₂-C₃₀ alkyl chain, optionally substituted by a hydroxy group, or
a heteroaryl group containing 1 to 4 nitrogen atoms, unsubstituted or substituted by a C₂-C₃₀ alkyl, or by a (CH₂)ₘ—O—(CH₂)ₚ—R₉ group in which m=1 to 6 and p=0 to 20 and R₉ represents hydrogen or a cyclic ketal group containing 5 to 7 carbon atoms, unsubstituted or substituted by at least one linear or branched C₂-C₃₀ alkyl, or by a sterol residue, or also
R₃ is linked by covalent bonding to another R₃ substituent, identical or different, of another compound of formula (I), identical or different, to form a compound of formula (I) in dimer form,

and
a step of separating the aggregate formed by said micropollutant in molecular form with said at least one nucleolipid compound of formula (I).

According to an aspect, the invention relates to a method for decontaminating an aqueous liquid medium containing at least one micropollutant in molecular form, or a surface contaminated with a micropollutant, comprising
a step of contacting said aqueous liquid medium containing at least one micropollutant in molecular form or said surface contaminated with at least one micropollutant with at least one nucleolipid compound of formula (I)

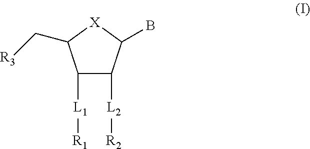

and
a step of separating the aggregate formed by said at least one micropollutant in molecular form with said at least one nucleolipid compound of formula (I) in said aqueous liquid medium or the aggregate formed by said at least one micropollutant with said at least one nucleolipid compound of formula (I) on said surface.

The invention also relates to the use of the compounds of formula (I) as defined above for decontaminating an aqueous liquid medium containing at least one micropollutant in molecular form, or a surface contaminated with such micropollutants.

The invention relates in particular to a method for decontaminating an aqueous liquid medium containing at least one micropollutant in molecular form, comprising
a step of contacting said aqueous liquid medium containing at least one micropollutant in molecular form with at least one nucleolipid compound of formula (I)

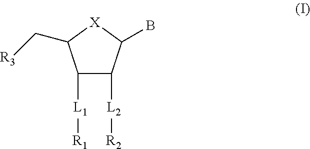

as defined above,

and
a step of separating the aggregate formed by said micropollutant in molecular form with said nucleolipid compound of formula (I).

In particular, the decontamination method according to the invention makes it possible to reduce the concentration of molecular micropollutant in said aqueous liquid medium or on said surface, preferably to a concentration less than that capable of causing an identified toxicity of said medium or of said surface.

Advantageously, the decontamination method according to the invention can make it possible to decontaminate an aqueous liquid medium in which said micropollutant is present at a very low concentration, in particular less than 1 mg per litre, in particular of the order of μg per litre.

The invention also relates to a method for decontaminating a surface contaminated with at least one micropollutant, comprising
a step of contacting said surface contaminated with at least one micropollutant with at least one nucleolipid compound of formula (I)

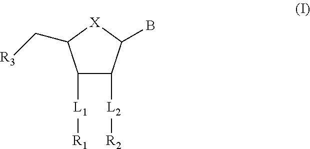

as defined above,

and
a step of separating the aggregate formed by said at least one micropollutant with said at least one nucleolipid compound of formula (I) on said surface.

In a particular aspect, said micropollutant contaminating said surface can be in molecular form.

In particular, said micropollutant in molecular form is a medicament, a derivative of a medicament or a metabolite of a medicament, human or veterinary.

For example, said micropollutant can be selected from the CMR (carcinogenic, mutagenic, reprotoxic) compounds or substances, cytotoxic medicaments classed as carcinogenic by the IARC (1 & 2), medicaments for which toxic effects on reproduction have been identified, sensitizing medicaments such as antibiotics (ofloxacin, ciprofloxacin, erythromycin), non-steroidal anti-inflammatories (diclofenac), beta-blockers (propranolol, metoprolol), psychotropics (carbamazepine, fluoxetine), acaricides (dichlorvos), alkaloids (caffeine) and oestrogens (ethinylestradiol).

The micropollutant can also be a phytosanitary product or a derivative of a phytosanitary product. For example, the rmicropollutant can be selected from herbicides (diuron, isoproturon, alachlor or aclonifen for example), insecticides (chlorfenvinphos for example) or fungicides (in particular the phenoxyquinoleines such as quinoxifen).

In a preferred embodiment, the micropollutant is selected from ofloxacin, ciprofloxacin, erythromycin, diciofenac, propranolol, metoprolol, carbamazepine, fluoxetine, dichlorvos, caffeine, ethinylestradiol, diuron, isoproturon, alachlor, aclonifen, chlorfenvinphos, and quinoxifen.

In another preferred embodiment, the micropollutant is selected from the CMR compounds or substances or a derivative or metabolite thereof. CMR substances are carcinogenic, mutagenic and/or reprotoxic substances that are in particular listed by the French National Research and Safety Institute for the Prevention of Occupational Accidents and Diseases (INRS).

In another preferred embodiment, the micropollutant is selected from the medicaments that have a recognized toxicity of the carcinogenic, teratogenic type, toxic for reproduction or development, genotoxic, or having an organ toxicity at very low concentration, or which are sensitizing.

For example, the micropollutant can be selected from the cytotoxic medicaments conventionally used in human clinical medicine in the treatment of cancers, such as cyclophosphamide, doxorubicin, a taxane such as paclitaxel or docetaxel, a platinum derivative or 5-fluorouracil.

According to an aspect of the invention, a single compound of formula (I) is used.

Alternatively, 2 or more than 2 different compounds of formula (I) are used, simultaneously or sequentially. Advantageously, the simultaneous or sequential use of distinct compounds of formula (I) allows the decontamination of different micropollutants.

By “aqueous liquid medium” is meant any mixture containing at least one liquid, the solvent of which is water, or a sample thereof.

By “decontamination of an aqueous liquid medium containing at least one micropollutant” is meant the fact of removing said micropollutant from said medium, totally or partially.

By “removing a micropollutant in molecular form from an aqueous liquid medium containing it” is meant the fact of trapping or capturing the molecules of micropollutant present in said medium, or reducing the concentration thereof, with a view to removing them totally or partially from said medium.

Without wishing to bind the invention to a theory, the hypothesis may be advanced according to which, in the method according to the invention, said molecules of micropollutant are trapped or captured by the nucleolipid compounds of formula (I) which interact therewith, without forming gel. On this basis, when the micropollutant is found in molecular form, in particular in a liquid medium, each molecule of micropollutant is capable of interacting separately with said compound of formula (I), thus significantly increasing the efficacy of the decontamination. This interaction makes it possible to form an aggregate, which it is then possible to remove from said liquid medium by a usual separation method.

By “decontaminating a surface contaminated by a micropollutant” is meant the fact of trapping or capturing the molecules of micropollutant present on said surface, or reducing the concentration thereof, with a view to removing them totally or partially from said surface.

By “micropollutant in molecular form”, “molecular micropollutant” or “molecule of micropollutant” is meant that said micropollutant has a size smaller than that of a particle of nanometric size (nanopartide).

By “nanopartides” is meant particles of nanometric size (or ultra-fine particles), according to standard ISO TS/27687, as being an assembly of molecules of which at least one of the dimensions is situated at nanometric scale. For example, a nanopartide can be defined according to the aforementioned ISO standard as being a nano-object the three dimensions of which are at nanometric scale, i.e. particles the nominal diameter of which is comprised between 0.5 nm and 100 nm.

According to the invention, said “micropollutant in molecular form” “molecular micropollutant” or said “micropollutant molecule”, these terms being used interchangeably, can be constituted by a single molecule.

In particular, said micropollutant in molecular form is a micropollutant one of the dimensions of which is less than 0.5 nm.

According to an aspect of the invention, said micropollutant in molecular form has a nominal diameter less than 0.5 nm.

According to an aspect of the invention, said micropollutant in molecular form is an organic molecule.

According to an aspect of the invention, said molecular micropollutant has a molar mass comprised between 60 g/mol and 5000 g/mol, preferably between 100 g/mol and 1000 g/mol.

Advantageously, said micropollutant in molecular form meets at least one of the definitions below, in particular when it is present in an aqueous liquid medium.

An aqueous liquid medium or sample thereof can be, for example, water for human or animal consumption, in particular drinking water; bathing water (reservoir or swimming pool); water used in the agri-food or pharmaceutical industry; water originating from a reservoir or a lake; coastal water, river water; surface water; groundwater, water for agricultural use, in particular for Irrigation; freshwater or seawater for aquaculture use, industrial water, in particular industrial wastewaters or effluents originating from a mine, hospital effluents, etc.; or any aqueous liquid medium in which the presence of micropollutants must be controlled, and, if necessary, which must undergo decontamination with respect to said micropollutant.

By way of example of surfaces that may be contaminated there may be mentioned for example, a usual surface found in a location receiving the public or animals, such as for example a leisure space, a laboratory, a hospital, an industrial site, an agricultural site, etc. in the form of a surface, flat or not flat, a covering surface, that of a manufactured object (such as laboratory equipment), etc. There may be mentioned for example surfaces that are based on glass (for example sodiocalcic or borosilicate glass, quartz glass), based on polymers such as polycarbonate, polyacrylate, polypropylene or polyvinyl chloride or PVC, based on silicone, or based on metals such as stainless steel.

The purine or pyrimidine base of the compound of formula (I) can for example be selected from adenine, guanine, cytosine, xanthine, hypoxanthine, uric acid, caffeine, theobromine, uracil, thymine, dihydrouridine, and derivatives thereof.

Thymine and uracil are preferred.

In the present description, the preferred aspects are applicable to all embodiments of the invention.

In formula (I) above, the purine or pyrimidine base can be substituted by at least one substituent selected for example from a halogen, an amino group, a carboxy group, a carbonyl group, a carbonylamino group, a hydroxy, azido, cyano or thiol group, a C₁-C₆ linear or branched alkyl group, a cycloalkyl, perfluoroalkyl, alkyloxy group (for example, methoxy), oxycarbonyl, vinyl, ethynyl, propynyl, acyl etc.

By “derivative based on purine or pyrimidine” is meant for example a non-natural mono- or bicyclic heterocyclic base in which each ring comprises 4 to 7 members, optionally substituted as indicated above.

By “non-natural mono- or bicyclic heterocyclic base” is meant for example a universal base, such as for example 3-nitropyrrole, 4-nitroimidazole or 5-nitroindole, which does not exist in nature.

By “heteroaryl group comprising 1 to 4 nitrogen atoms” is meant a mono- or bicyclic carbocyclic group, aromatic or partially unsaturated, comprising 5 to 12 atoms in total, interrupted by 1 to 4 nitrogen atoms, which can be selected for example from the furan, pyrrole, oxazole, oxadiazole, isoxazole, pyrazole, triazole, tetrazole, imidazole, pyridine, pyrimidine, pyridazine, pyrazine, benzofuran, indole, quinoline, isoquinoline, chromane, naphthyridine and benzodiazine groups, triazole being preferred.

In formula (I) above, the acyl chain, when it is present, is a C₈-C₃₀ chain, preferably C₈-C₂₆, and more preferably a C₁₆-C₂₀ acyl chain.

The linear or branched hydrocarbon chain, when it is present, is a C₈-C₃₀ chain, preferably C₈-C₂₆, and more preferably a C₁₆-C₂₀ chain, saturated or containing one or more unsaturations.

The linear or branched alkyl chain, when it is present, is a C₂-C₃₀ chain, preferably C₂-C₂₀, and more preferably C₈-C₂₀.

If necessary, the counterion can be selected for example from the monovalent cations, such as Na⁺, Li⁺, K⁺, NH₄⁺.

Alternatively, when in formula (I) defined above, R₃ represents a cationic group, for example a phosphonium or NR₄R₅R₆ group as defined above, the counterion can be selected for example from the tosylate, halide, nitrate, sulfate, sulfonate, and thiosulfate anions.

Thus, in the absence of counterion, the compounds of formula (I) can be negatively charged, as for example the compound Thymidine 3′-(1,2-dipalmitoyl-sn-glycero-3-phosphate), also called diC16dT, or positively, as for example the compound (N-[5′-(2′,3′-dioleoyl)uridine]-N′,N′,N′-trimethylammonium tosylate) also called DOTAU.

According to an embodiment, at least one compound of formula (I) is used, in which:
X is an oxygen atom, sulfur atom or a methylene group
B represents a purine or pyrimidine base;
L₁ and L₂, identical or different, represent hydrogen, an —O—C(O)— oxycarbonyl group, an —O—C(S)—NH— thiocarbamate group, an —O—C(O)—O-carbonate group, an —O—C(O)—NH— carbamate group, an oxygen atom, a phosphate group, a phosphonate group or a heteroaryl group comprising 1 to 4 nitrogen atoms, substituted or unsubstituted by a saturated or unsaturated, linear or branched C₈-C₃₀ hydrocarbon chain;
R₁ and R₂, identical or different, represent
a linear or branched C₈-C₃₀ hydrocarbon chain, saturated or comprising one or more unsaturations,
a C₈-C₃₀ acyl chain,
a diacyl chain in which each acyl chain is C₈-C₃₀,
a diacylglycerol group in which each acyl chain is C₈-C₃₀,
R₃ represents an NH₂—R₄, NHR₄R₅ or NR₄R₅R₆ group in which R₄, R₅ and R₆, identical or different, represent a hydrogen atom or a linear or branched C₁-C₆ alkyl or linear or branched C₁-C₆ hydroxyalkyl chain, or a heteroaryl group containing 1 to 4 nitrogen atoms, unsubstituted or substituted by a C₂-C₃₀ alkyl, or by a (CH₂)ₘ—O—(CH₂)ₚ—R₉ group in which m=1 to 6 and p=0 to 20 and R₉ represents hydrogen.

Preferred nucleolipid compounds of formula (I) for the purposes of the invention are those in which:
X is an oxygen atom;
B is chosen from adenine, guanine, cytosine, thymine and uracil, thymine and uracil being preferred;
L₁ and L₂, identical or different, represent an —O—C(O)— oxycarbonyl group, an —O—C(O)—O— carbonate group, an —O—C(O)—NH— carbamate group, an oxygen atom or a phosphate group and/or one from L₁ and L₂ represents hydrogen;
R₁ and R₂, identical or different, represent a linear or branched C₈-C₃₀ hydrocarbon chain, saturated or comprising one or more unsaturations, a C₈-C₃₀, acyl chain, a diacyl chain in which each acyl chain is C₈-C₃₀, or a diacylglycerol group in which each acyl chain is C₈-C₃₀;
R₃ represents a hydroxy, amino, phosphate, phosphonate, thiophosphate, phosphonium, NH₂—R₄, NHR₄R₅ or NR₄R₅R₆ group in which R₄, R₅ and R₆, identical or different, represent a hydrogen atom or a linear or branched C₁-C₆ alkyl or linear or branched C₁-C₆ hydroxyalkyl chain.

Preferred nucleolipid compounds of formula (I) for the purposes of the Invention are those in which:
X is an oxygen atom;
B is chosen from adenine, guanine, cytosine, thymine and uracil, thymine and uracil being preferred;
L₁ is a phosphate group substituted by an R₁ group, in which R₁ is a diacylglycerol group in which each acyl group is C₈-C₃₀, preferably C₈-C₂₆, or more preferably C₁₁-C₂₀, L₂ is hydrogen and R₂ is not present, or
L₁ and L₂ represent respectively an —O—C(O)— oxycarbonyl group substituted by an R₁ group and an —O—C(O)— oxycarbonyl group substituted by an R₂ group, and R₁ and R₂, identical or different, each represent a linear or branched C₈-C₃₀ hydrocarbon chain, preferably C₁₆-C₂₀, containing one or more unsaturations,
R₃ is a hydroxy group or an NR₄R₅R₆ group in which R₄, R₅ and R₆ represent a hydrogen atom.

In particular, the compounds of formula (I) will be used in which:
X is an oxygen atom;
B is thymine;
L₁ is a phosphate group substituted by an R₁ group, in which R₁ is a diacylglycerol group in which each acyl group is C₈-C₃₀, preferably C₈-C₂₆, or more preferably C₁₆-C₂₀, L₂ is hydrogen and R₂ is not present, and,
R₃ is a hydroxy group.

Other preferred compounds of formula (I) are those in which:
X is an oxygen atom;
B represents uracil;
L₁ represents an —O—C(O)— oxycarbonyl group substituted by an R₁ group,
L₂ represents an —O—C(O)— oxycarbonyl group substituted by an R₂ group,
R₁ and R₂, identical or different, each represent a linear or branched C₈-C₃₀ hydrocarbon chain, preferably C₁₆-C₂₀, containing one or more unsaturations,
R₃ is an NR₄R₅R₆ group in which R₄, R₅ and R₆ represent a hydrogen atom.

Particularly preferred compounds of formula (I) are the compounds:
Thymidine 3′-(1,2-dipalmitoyl-sn-glycero-3-phosphate), also called diC16dT (CAS Registry Number: 1160002-70-9);
(N-[5′-(2′,3′-dioleoyl)uridine]-N′,N′,N′-trimethylammonium tosylate) also called DOTAU, prepared as described in P. Chabaud et al., Bioconjugate Chem., 2006, 17, 466-472.

For the preparation of the compounds of formula (I), reference may be made to patent application WO 2005/116043, which describes different access routes to this type of compounds (in particular p. 8-17 and Examples), as well as patent applications WO2009/098404 or WO2010/136676 and to the publication P. Chabaud et al., Bioconjugate Chem., 2006, 17, 466-472 (preparation of DOTAU).

According to an embodiment of the invention, a nucleolipid compound of formula (I) is used in dimer form in which a first molecule of formula (I) having an R₃ group is bound to a second molecule of formula (I) having an R₃ group identical or different to the R₃ group of the first molecule of formula (I), the bond between the R₃ group of the first molecule of formula (I) and the R₃ group of the second molecule of formula (I) being a covalent bond.

According to a preferred aspect, the invention relates to a method for decontaminating an aqueous liquid medium containing at least one micropollutant in molecular form, or a surface contaminated with at least one such micropollutant, comprising
a step of contacting said aqueous liquid medium containing at least one micropollutant in molecular form or said surface contaminated with a micropollutant with at least one nucleolipid compound of formula (I) as defined above,
a step of Incubating said aqueous liquid medium containing at least one micropollutant in molecular form or said surface contaminated with a micropollutant with at least one nucleolipid compound of formula (I) as defined above, and
a step of separating the aggregate formed by said micropollutant in molecular form with said at least one nucleolipid compound of formula (I).

According to an aspect, the invention relates to a method for decontaminating an aqueous liquid medium containing at least one micropollutant in molecular form, or a surface contaminated with at least one micropollutant, comprising
a step of contacting said aqueous liquid medium containing at least one micropollutant in molecular form or said surface contaminated with a micropollutant with at least one nucleolipid compound of formula (I) as defined above,
a step of Incubating said aqueous liquid medium containing at least one micropollutant in molecular form or said surface contaminated with at least one micropollutant with at least one nucleolipid compound of formula (I) as defined above, and
a step of separating the aggregate formed by said at least one micropollutant in molecular form with said at least one nucleolipid compound of formula (I) in said aqueous liquid medium or the aggregate formed by said at least one micropollutant with said at least one nucleolipid compound of formula (I) on said surface.

By “incubation” is meant a period of contact carried out for a duration sufficient to allow the interaction of the compound(s) of formula (I) with the molecular micropollutant(s) present in the aqueous liquid medium or on the surface. Merely by way of indication, it is possible for example to carry out incubation for a duration from 1 min to 4 hours, in particular from 5 min to 2 hours.

This incubation can be carried out, for example, at ambient temperature.

Contacting can be carried out for example by dissolution or dispersion of the nucleolipid compound of formula (I) in the aqueous medium, by application on the contaminated surface of a solution or a suspension of the nucleolipid compound of formula (I) in a suitable solvent such as water or an organic solvent, or by application on said contaminated surface of a powder comprising, preferably constituted by, the nucleolipid compound of formula (I).

Advantageously, the total concentration of compound(s) of formula (I) in solution or in suspension in a suitable solvent such as water or an organic solvent can be comprised between 0.001 mg/mL and 1 mg/mL, preferably less than 1 mg/mL, in particular from 0.01 mg/mL to 0.5 mg/mL, in particular from 0.1 to 0.5 mg/mL.

Advantageously, said compound of formula (I) does not form a gel at the concentration used for the decontamination.

The separation can be carried out for example by decantation, centrifugation, filtration, mechanical wiping, etc. according to the known techniques in the technical field, as a function of the aqueous liquid medium and of the volume to be treated, or as a function of the surface to be treated.

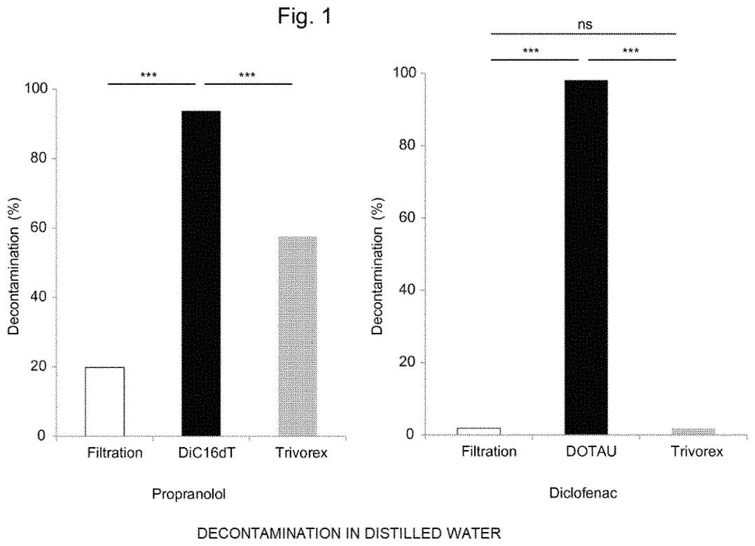

FIG. 1 shows the decontamination levels obtained for Propranolol® or Didofenac® in distilled water, in the presence or in the absence of a nucleolipid compound of formula (I).

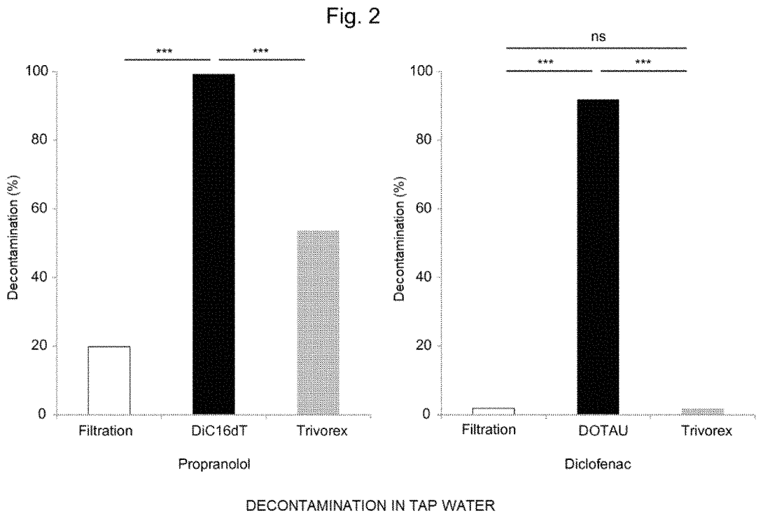

FIG. 2 shows the decontamination levels obtained for Propranolol® or Didofenac® in tap water, in the presence or in the absence of a nucleolipid compound of formula (I).

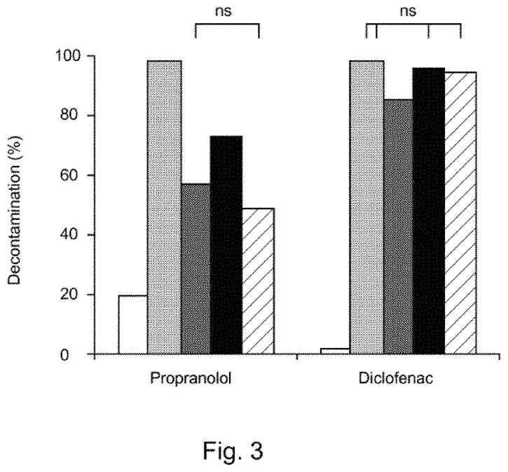

FIG. 3 shows the decontamination levels obtained for solutions of Propranolol® and Diclofenac® containing either a nucleolipid of formula (I) (DOTAU or diC16dT), or both nucleolipids, added simultaneously or successively.

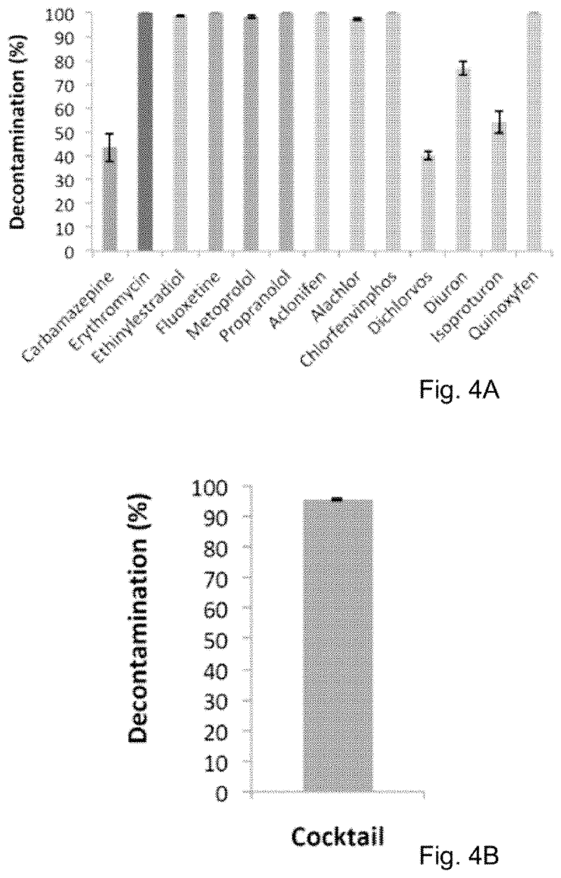

FIG. 4 represents the decontamination level obtained for each of the 13 micropollutants tested (FIG. 4A), as well as the overall level of decontamination of the cocktail of micropollutants (solution containing the 13 micropollutants) (FIG. 4B).

The invention is illustrated by the following Examples.

### Example 1: Decontamination of an Aqueous Liquid Medium Containing Propranolol® or Didofenac® by a Nucleolipid Compound of Formula (I)

Propranolol® and Didofenac® were used (Sigma-Aldrich).

The nucleolipids of formula (I) diC16dT and DOTAU were prepared according to the procedures described respectively in Khiati et al., Bioconjug. Chem, 2009, 20, 1765-1772, Bioconjug. Chem, 2009, 20, 1765-1772 and Chabaud et al., Bioconjug. Chem., 2006, 17, 466-472. By way of comparison, a commercially available decontaminant compound in powder form, Trivorex® (Prevor) was also used.

1/ Preparation of a Calibration Solution of Propranolol®. Diclofenac® and Trivorex®

7 mg of product (medicament or Trivorex®) are added to 7 ml deionized water (stock solution: 1 mg/mL).

The λmax was determined by spectrometer measurements for each compound. Different solutions were produced based on their stock solutions and assayed in 100 μl quartz cells with a UV Jacso V-630 spectrometer. The epsilon of each compound is determined at 258 nm, 266 nm, 276 nm and 289 nm (A=a×C+b with A the absorbance, C the concentration, a is the epsilon and b is the value of the y-axis at the origin).

The Trivorex® does not absorb in distilled water solution. The same protocol was used in tap water (the epsilon does not change in tap water).

The concentrations of the working solutions were thus determined for Propranolol® at 50 μg/mL and for Didofenac® at 20 μg/mL, for respective absorption wavelengths of 289 nm and 276 nm.

2/ Study of the Decontamination of Propranolol® by diC16-3′-dT and Diclofenac® by DOTAU

The experiments were conducted in triplicate. 10 mg of DiC16dT was added to 50 mL of solution to be decontaminated (solution of Propranolol® at 50 μg/mL in distilled water or in tap water).

After incubation (15 min in deionized water or 2 hours in tap water) under magnetic stirring at ambient temperature, 600 μL of this solution was filtered over Millex-GS 0.22 μm membrane, MF-Millipore.

The spectra of the samples were acquired using a UV spectrophotometer with 100 μL quartz cells. The final concentrations of Propranolol® and the decontamination percentages were calculated by the multicomponent mode method (Wagdarikar et al., Pharm. Sci. Res., 2015, 545, 2013-2018).

The same protocol was used for a solution of Didofenac® at 20 μg/mL in distilled water or in tap water and using DOTAU, with an incubation time under magnetic stirring of 10 min in distilled water or 30 min in tap water.

The same protocol was followed, replacing the nucleolipid component with Trivorex® for each of the medicaments.

By way of comparison, solutions containing only Propranolol® or Didofenac® (respectively at 50 μg/mL and 20 μg/mL) in distilled water or in tap water were also subjected to a simple filtration over Millex-GS 0.22 μm MF-Millipore membrane, in the absence of nucleolipid compound.

For determining the real concentrations of Propranolol® and of Didofenac® and the percentage decontamination, formulae 1 and 2 below were applied.

$$\begin{matrix}Formula 1 \text{:} Determining the real conectration of Propranolol ® and \\ the percentage decontamination by the multicomponent method . & \\ [ Propranolol ] experimental = \frac{\begin{matrix}A mixture 266 nm \times ɛ DiC 16 d T 289 nm - \\ ɛ DiC 16 d T 266 nm \times A mixture 289 nm\end{matrix}}{\begin{matrix}ɛ Propranolol 266 nm \times ɛ DiC 16 dT 289 nm - \\ ɛ DiC 16 dT 266 nm \times ɛ Propranolol 289 nm\end{matrix}} \\ \% decontamination = 100 - ( \frac{[ Propranolol ] experimental}{[ Propranolol ] working solution} \times 100 ) & \\ Formula 2 \text{:} Determining the real conectration of Diclofenac ® and the percentage decontamination by the multicomponent method . & \\ [ Diclofenace ] experimental = \frac{\begin{matrix}A mixture 266 nm \times ɛ DOTAU 276 nm - \\ ɛ DOTAU 258 nm \times A mixture 276 nm\end{matrix}}{\begin{matrix}ɛ Diclofenac 258 nm \times ɛ DOTAU 276 nm - \\ ɛ DOTAU 258 nm \times ɛ Diclofenac 276 nm\end{matrix}} \\ \% decontamination = 100 - ( \frac{[ Diclofenac ] experimental}{[ Diclofenac ] working solution} \times 100 ) & \end{matrix}$$

3/ Data Analysis

Data analysis was carried out by testing the normality (Shapiro-Wilk test) and the homoscadasticity (Bartlett's test), then the ANOVA parametric test was used for detecting the significant differences between the decontamination methods.

When the ANOVA test was significant (p<0.05), the post-hoc Tukey test was used and was noted as follows: not significant (ns) for p<0.05, weakly significant (*) for p<0.05), very significant (**) for p<0.005, highly significant (***) for p<0.0005.

4/ Results

The results are summarized in FIGS. 1 and 2.

a) FIG. 1 shows the decontamination levels obtained for Propranolol® or Diclofenac® in distilled water, under the following conditions:
filtration alone, in the absence of compound of formula (I) (column in white);
addition of a compound of formula (I), namely DOTAU or diC16dT, followed by a filtration (column in black);
addition of Trivorex®, in the absence of compound of formula (I), followed by a filtration (column in grey).

A high level of decontamination is observed for the solution containing Propranolol® in the presence of diC16dT (93.69±2.04%) and for the solution containing Diclofenac® in the presence of DOTAU (98.03±0.51%). These decontamination levels are significantly higher than those obtained with Trivorex®, respectively of 55 t 5% (for the Propranolol®) and less than 5% (for the Didofenac®).

It is observed that the filtration alone over cellulose membrane gives a low level of decontamination (19.80±1.22%) for the solution containing Propanolol®, which has an affinity for the cellulose membrane, and a level of decontamination of almost zero for the solution containing Didofenac® (1.86±0.17%).

b) FIG. 2 shows the decontamination levels obtained for Propranolol® or Didofenac® in tap water, under the same conditions.

Similar results are observed to those obtained in distilled water: the only effective decontamination is that obtained by using the nucleolipids of formula (I) DOTAU or diC16dT.

### Example 2: Study of the Decontamination of Propranol® and Didofenac® in the Presence of Several Nucleolipids of Formula (I)

Measurements were carried out on solutions of Propranolol® and Didofenac® containing either a nucleolipid of formula (I) (DOTAU or diC16dT), or both nucleolipids, added successively or simultaneously. By way of comparison, a measurement was also carried out with filtration alone, in the absence of compound of formula (I).

The different mixtures below were produced in triplicate.

For each medicament a mixture was prepared by adding 10 mg of nucleolipid DOTAU or diC16dT to 50 mL of solution of medicament, then 10 mg of nucleolipid DOTAU or diC16dT different from the first addition, or by dissolving 10 mg of each nucleolipid at the same time in 50 mL of solution of medicament. In both cases, a filtration was then carried out.

The measurements were taken after different incubation times at ambient temperature. The results are summarized in FIG. 3.

For Propranolol® (at 50 μg/mL), the following conditions were used:
addition of diC16dT and Incubation 15 min (column In light grey);
addition of diC16dT and incubation 15 min, then addition of DOTAU and incubation 60 min (column in dark grey);
simultaneous addition of diC16dT and DOTAU and incubation 15 min (column in black);
simultaneous addition of diC16dT and DOTAU and incubation 120 min (hatched column).

For Didofenac® (at 20 μg/mL), the following conditions were used:
addition of DOTAU and incubation 10 min (column in light grey);
addition of DOTAU and incubation 10 min, then addition of diC16dT and incubation 60 min (column in dark grey);
simultaneous addition of diC16dT and DOTAU and incubation 10 min (column in black);
simultaneous addition of diC16dT and DOTAU and incubation 120 min (hatched column).

At these different times, the decontamination is measured using a UV spectrophotometer (100 μL quartz cells) after having filtered 600 μL of working solution over Millex®-GS 0.22 μm membrane, MF-Millipore.

By way of comparison, a measurement was also carried out for each of the medicaments after filtration alone, in the absence of nucleolipid compound of formula (I) (DOTAU or diC16dT) (column in white).

5/ Results

The results, summarized in FIG. 3, show that:
in all cases, the addition of nucleolipid(s) of formula (I) (DOTAU and/or diC16dT), alone or in combination, allow effective and significant decontamination to be obtained, in comparison with filtration, which does not allow a satisfactory decontamination level to be obtained;
for Diclofenac®, no significant difference was observed between the decontamination performed by DOTAU alone (97.06±1.35% after 10 min) or that performed by sequential or simultaneous addition of DOTAU and diC16dT. Nor does the incubation time result in any significant difference;
for Propranolol®, the decontamination performed by diC16dT alone shows a level of 93.69±2.04% and it is observed that the simultaneous addition of DOTAU and diC16dT makes it possible to obtain a decontamination level of 72.71±2.44% after only 15 min.

These results make it possible to envisage the use of two different nucleolipids for decontaminating an aqueous liquid medium containing different types of micropollutants.

### Example 3: Study of the Decontamination of Aqueous Mediums Comprising a Mixture of Micropollutants with diC16dT

The aim of this study is to test a system for decontaminating water according to the invention on pure water artificially contaminated with 13 micropollutants (“cocktail”).

These 13 micropollutants are the following medicaments and pesticides: erythromycin, propranolol, metoprolol, carbamazepine, fluoxetine, dichlorvos, ethinylestradiol, diuron, isoproturon, alachlor, aconifen, chlorfenvinphos, and quinoxifen.

The 13 micropollutants were diluted at concentrations at least 10 times greater than the limits of detection thereof in 500 mL of water.

3 replicates of 50 mL of this solution were decontaminated with diC16dT and according to the same method of operation as that in Example 1, and the 4 samples (3 decontaminated samples+50 mL of non-decontaminated solution) were analyzed by LC-MS.

Materials and Methods

Chemical Products and Solvents

The analytical standards were purchased in analytical quality with a purity of ≥98% from Sigma-Aldrich (St Quentin Fallavier, France).

All the solvents used are of quality Optima™ LC-MS (Fisher Scientific, Illkirch, France), including the water used to create the 500 mL solution.

Preparation of the Stock and Working Solutions

The stock solutions (1 mg/mL) were prepared by diluting approximately exactly 1 mg of each standard in the corresponding volume of the appropriate solvents. The standards were weighed on Quintix 35-1S analysis scales (Sartorius, Aubagne, France).

In order to limit the degradation of the standards, all the solutions were kept at −20° C. immediately after preparation and until use.

LC-MS Analysis

Liquid Chromatography

The separation by chromatography was carried out with an HTC PAL automated sampling system (CTC Analytics AG, Zwingen, Switzerland) coupled with a HPLC Dionex Ultimate 3000 system (ThermoFisher Scientific, Les Ullis, France) equipped with two pumps (charging and elution) and a VIM (Valve Interface Module) making it possible to elute the SPE online in backflush mode.

Mass Spectrometry

The analyses were carried out in positive mode with a Q-Exactive (ThermoFisher Scientific, Les Ullis, France) equipped with a HESI (Heated Electrospray Ionisation) source (ThermoFisher Scientific, Les Ullis, France).

Acquisition and Exploitation of the Results

The acquisition and exploitation of the results was carried out with the Xcalibur software (ThermoFisher Scientific, Les Ullis, France). The signal corresponding to each of the contaminants was validated according to its m/z (with a tolerance set at 5 ppm) and retention time, and reintegrated manually if necessary.

Calibration curves were obtained for each molecule in LC-MS quality water with concentrations reaching twice the initial concentration of the test solution. The parameters of these calibration curves (slope, y-axis at the origin and linear regression coefficient) were obtained using Excel software, which was then used to quantify each molecule in the samples.

The results obtained are presented in Table 1 below.

For each molecule, the concentrations before and after decontamination (in μg/L) in each sample, the percentage decontamination and the standard deviation are shown.

TABLE 1

| | Before | After | | Standard |
|---|---|---|---|---|
| | decontamination | decontamination | Decontamination | deviation |
| Micropollutant | (μg/L) | (μg/L) | (%) | (%) |
| Carbamazepine | 0.128 | 0.072 | 43.49 | 6.07 |
| Erythromycin | 3.998 | 0 (<LoD)* | 100 | 0 |
| Ethinylestradiol | 1.912 | 0.023 | 98.80 | 0.55 |
| Fluoxetine | 0.103 | 0 (<LoD) | 100 | 0 |
| Metoprolol | 0.104 | 0.0017 | 98.40 | 0.56 |
| Propranolol | 0.085 | 0 (<LoD) | 100 | 0 |
| Aclonifen | 3.762 | 0 (<LoD) | 100 | 0 |
| Alachlor | 0.092 | 0.0023 | 97.46 | 0.63 |
| Chlorfenvinphos | 0.075 | 0 (<LoD) | 100 | 0 |
| Dichlorvos | 0.094 | 0.056 | 40.07 | 1.63 |
| Diuron | 0.098 | 0.023 | 76.87 | 3.12 |
| Isoproturon | 0.993 | 0.46 | 54.08 | 4.60 |
| Quinoxifen | 2.688 | 0 (<LoD) | 100 | 0 |
| Cocktail | 14.132 | 0.63 | 95.51 | 0.48 |

*LoD = limit of detection

FIG. 4 represents the decontamination level obtained for each of the 13 micropollutants (FIG. 4A), as well as the overall decontamination level of the cocktail (solution containing the 13 micropollutants) (FIG. 4B3).

The results show that the method according to the invention makes it possible to obtain a significant decontamination for very low concentrations of micropollutants, of the order of or less than 1 μg/L.

For a cocktail of micropollutants, the results show that the decontamination is effective for a total concentration of several tens of μg/L.

### Example 4: Decontamination of Contaminated Surface (Glass Slide)

10 μL of Quantum Dots (CdSeS/ZnS, 1 g.L⁻¹ in toluene, 6 nm) was deposited on a glass slide (Marienfeld 76×26×1 mm, pure white glass, cut edges, plain). It was allowed to evaporate under a hood for 1 hour. Then 20 μL of decontaminating solution was deposited.

The tests were carried out with a solution of DOTAU in water at 1% m/V or in an ionic liquid, 1-butyl-3-methylimidazolium bis(trifluoromethylsulfonyl)-imide (BMIM TFSI) at 1% m/V (i.e. 10 mg/mL).

After having left the decontaminating solution in contact with the contaminated glass slide for 15 min, the slide was cleaned by passing a wiper (Kimtech 05511) once vertically, then once horizontally. The slide is observed under UV (366 nm) and photographed.

By way of comparison, observation was also carried out of a contaminated slide before treatment, a contaminated slide with simple wiping with a wiper without contact with the decontaminating solution, and contaminated slides subjected to contact with water or ionic liquid, followed by wiping.

The contaminated slides are photographed before and after treatment, then the photos are processed with Mesurim® and Image J® image processing software.

The results obtained are presented in Table 2 below, expressed as percentage decontamination.

TABLE 2

| Treatment after decontamination | % decontamination |
|---|---|
| Wiper | 22% |
| Water only | 28% |
| Solution of DOTAU in water | 40% |
| BMIM TFSI only | 42% |
| Solution of DOTAU in BMIM TFSI | 74% |

The results show that the presence of DOTAU in the decontaminating solution significantly increases the decontamination of the glass slide.

1. Method for decontaminating an aqueous liquid medium containing at least one micropollutant in molecular form, or a surface contaminated with a micropollutant, comprising
a step of contacting said aqueous liquid medium containing said at least one micropollutant in molecular form or said surface contaminated with said at least one micropollutant with at least one nucleolipid compound of formula (I) 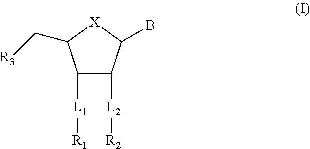
in which
X is an atom of oxygen, sulfur or a methylene group
B represents a purine or pyrimidine base, or also a non-natural heterocyclic mono- or bicyclic base, each ring of which comprises 4 to 7 members, optionally substituted;
L₁ and L₂, identical or different, represent hydrogen, an —O—C(O)— oxycarbonyl group, an —O—C(S)—NH— thiocarbamate group, an —O—C(O)—O— carbonate group, an —O—C(O)—NH— carbamate group, an oxygen atom, a phosphate group, a phosphonate group or a heteroaryl group comprising from 1 to 4 nitrogen atoms, substituted or unsubstituted by a saturated or unsaturated, linear or branched C₈-C₃₀ hydrocarbon chain;
where L₁ represents a phosphate or phosphonate group and L₂ represents hydrogen;
or also, L₁ and L₂ together form a ketal group of formula 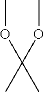
or also L₁ or L₂ represents hydrogen, and the other represents a hydroxy group or a heteroaryl group comprising 1 to 4 nitrogen atoms, unsubstituted or substituted by a linear or branched C₈-C₃₀ alkyl chain;
R₁ and R₂, identical or different, represent:
a linear or branched C₈-C₃₀ hydrocarbon chain, saturated or comprising one or more unsaturations,
a C₈-C₃₀ acyl chain,
a diacyl chain in which each acyl chain is C₈-C₃₀,
a diacylglycerol chain in which each acyl chain is C₈-C₃₀,
a sphingosine or ceramide group, or
when L₁ or L₂ represents hydrogen, and the other represents a hydroxy group or a heteroaryl group comprising 1 to 4 nitrogen atoms, R₁ and R₂ are not present;
R₃ represents:
a hydroxy, amino, phosphate, phosphonate, phosphatidylcholine, O-alkyl phosphatidylcholine, thiophosphate, phosphonium, NH₂—R₄, NHR₄R₅ or NR₄R₅R₆ group in which R₄, R₅ and R₆, identical or different, represent a hydrogen atom or a linear or branched C₁-C₆ alkyl or linear or branched C₁-C₆ hydroxyalkyl chain, or
a linear or branched C₂-C₃₀ alkyl chain, optionally substituted by a hydroxy group, or
a heteroaryl group containing 1 to 4 nitrogen atoms, unsubstituted or substituted by a C₂-C₃₀ alkyl, or by a (CH₂)ₘ—O—(CH₂)ₚ—R₉ group in which m=1 to 6 and p=0 to 20 and R₉ represents hydrogen or a cyclic ketal group containing 5 to 7 carbon atoms, unsubstituted or substituted by at least one linear or branched C₂-C₃₀ alkyl, or by a sterol residue, or also
R₃ is linked by covalent bonding to another R₃ substituent, identical or different, of another compound of formula (I), identical or different, to form a compound of formula (I) in dimer form,
and
a step of separating the aggregate formed by said at least one micropollutant in molecular form with said at least one nucleolipid compound of formula (I) in said aqueous liquid medium or the aggregate formed by said at least one micropollutant with said at least one nucleolipid compound of formula (I) on said surface.

2. Method according to claim 1, in which
the contacting step is a step of contacting an aqueous liquid medium containing at least one micropollutant in molecular form with at least one nucleolipid compound of formula (I) as defined in claim 1,
and
the separation step is a step of separating the aggregate formed by said micropollutant in molecular form with said at least one nucleolipid compound of formula (I).

3. Method according to claim 1, in which
the contacting step is a step of contacting said surface contaminated with at least one micropollutant with at least one nucleolipid compound of formula (I) as defined in claim 1,
and
the separation step is a step of separating the aggregate formed by said at least one micropollutant with said at least one nucleolipid compound of formula (I) on said surface.

4. Method according to claim 1, in which a single compound of formula (I) is used.

5. Method according to claim 1, in which 2 or more than 2 different compounds of formula (I) are used simultaneously or sequentially.

6. Method according to claim 1, comprising
a step of contacting said aqueous liquid medium containing at least one micropollutant in molecular form or said surface contaminated with at least one micropollutant with at least one nucleolipid compound of formula (I),
a step of incubating said aqueous liquid medium containing at least one micropollutant in molecular form or said surface contaminated with a micropollutant with at least one nucleolipid compound of formula (I), and
a step of separating the aggregate formed by said micropollutant in molecular form with said at least one nucleolipid compound of formula (I) in said aqueous liquid medium or the aggregate formed by said micropollutant with said at least one nucleolipid compound of formula (I) on said surface.

7. Method according to claim 1, in which contacting is carried out by dissolution or dispersion of the nucleolipid compound of formula (I) in the aqueous medium, by application on the contaminated surface of a solution or a suspension of nucleolipid compound of formula (I) in a suitable solvent such as water or an organic solvent, or by application on said contaminated surface of a powder comprising the nucleolipid compound of formula (I) or constituted by the nucleolipid compound of formula (I).

8. Method according to claim 1, in which said micropollutant in molecular form meets at least one of the following conditions:
it is constituted by a single molecule;
one of its dimensions is less than 0.5 nm;
it has a nominal diameter less than 0.5 nm;
it has a molar mass comprised between 60 g/mol and 5000 g/mol, preferably between 100 g/mol and 1000 g/mol;
it is an organic molecule.

9. Method according to claim 1, in which, in formula (I), B represents a purine or pyrimidine base selected from adenine, guanine, cytosine, xanthine, hypoxanthine, uric acid, caffeine, theobromine, uracil, thymine, dihydrouridine, and derivatives thereof, preferably thymine or uracil.

10. Method according to claim 1, in which at least one compound of formula (I) is used in which:
X is an atom of oxygen, sulfur or a methylene group
B represents a purine or pyrimidine base;
L₁ and L₂, identical or different, represent hydrogen, an —O—C(O)— oxycarbonyl group, an —O—C(S)—NH— thiocarbamate group, an —O—C(O)—O— carbonate group, an —O—C(O)—NH— carbamate group, an oxygen atom, a phosphate group, a phosphonate group or a heteroaryl group comprising from 1 to 4 nitrogen atoms, substituted or unsubstituted by a saturated or unsaturated, linear or branched C₈-C₃₀ hydrocarbon chain;
R₁ and R₂, identical or different, represent:
a linear or branched C₈-C₃₀ hydrocarbon chain, saturated or comprising one or more unsaturations,
a C₈-C₃₀ acyl chain,
a diacyl chain in which each acyl chain is C₈-C₃₀,
a diacylglycerol group in which each acyl chain is C₈-C₃₀,
R₃ represents a NH₂—R₄, NHR₄R₅ or NR₄R₅R₆ group, in which R₄, R₅ and R₆, identical or different, represent a hydrogen atom or a linear or branched C₁-C₆ alkyl chain or linear or branched C₁-C₆ hydroxyalkyl chain, or a heteroaryl group containing 1 to 4 nitrogen atoms, unsubstituted or substituted by a C₂-C₃₀ alkyl, or by a (CH₂)ₘ—O—(CH₂)ₚ—R₉ group in which m=1 to 6 and p=0 to 20 and R₉ represents hydrogen.

11. Method according to claim 1, in which a nucleolipid compound of formula (I) is used in which:
X is an oxygen atom;
B is chosen from adenine, guanine, cytosine, thymine and uracil;
L₁ and L₂, identical or different, represent an —O—C(O)— oxycarbonyl group, an —O—C(O)—O— carbonate group, an —O—C(O)—NH— carbamate group, an oxygen atom or a phosphate group and/or one from de L₁ and L₂ represents hydrogen;
R₁ and R₂, identical or different, represent a linear or branched C₈-C₃₀ hydrocarbon chain, saturated or comprising one or more unsaturations, a C₈-C₃₀ acyl chain, a diacyl chain in which each acyl chain is C₈-C₃₀, or a diacylglycerol group in which each acyl chain is C₈-C₃₀;
R₃ represents a hydroxy, amino, phosphate, phosphonate, thiophosphate, phosphonium, NH₂—R₄, NHR₄R₅ or NR₄R₅R₆ group in which R₄, R₅ and R₆, identical or different, represent a hydrogen atom or a linear or branched C₁-C₆ alkyl or linear or branched C₁-C₆ hydroxyalkyl chain.

12. Method according to claim 1, in which a nucleolipid compound of formula (I) is used in which:
X is an oxygen atom;
B is chosen from adenine, guanine, cytosine, thymine and uracil, preferably uracil or thymine;
L₁ is a phosphate group substituted by an R₁ group, in which R₁ is a diacylglycerol group in which each acyl group is C₈-C₃₀, L₂ is hydrogen and R₂ is not present, or
L₁ represents an —O—C(O)— oxycarbonyl group substituted by an R₁ group and L₂ represents and an —O—C(O)— oxycarbonyl group substituted by an R₂ group, and R₁ and R₂, identical or different, each represent a linear or branched C₈-C₃₀ hydrocarbon chain, containing one or more unsaturations;
R₃ is a hydroxy group or an NR₄R₅R₆ group in which R₄, R₅ and R₆ represent a hydrogen atom.

13. Method according to claim 12, in which a nucleolipid compound of formula (I) is used in which:
X is an oxygen atom;
B is thymine;
L₁ is a phosphate group substituted by an R₁ group, in which R₁ is a diacylglycerol group in which each acyl group is C₈-C₃₀, preferably C₈-C₂₆, or more preferably C₁₆-C₂₀, L₂ is hydrogen and R₂ is not present, and
R₃ is a hydroxy group.

14. Method according to claim 12, in which a nucleolipid compound of formula (I) is used in which:
X is an oxygen atom;
B represents uracil;
L₁ represents an —O—C(O)— oxycarbonyl group substituted by an R₁ group,
L₂ represents an —O—C(O)— oxycarbonyl group substituted by an R₂ group,
R₁ and R₂, identical or different, each represent a linear or branched C₈-C₃₀ hydrocarbon chain, preferably C₁₆-C₂₀, containing one or more unsaturations,
R₃ is an NR₄R₅R₆ group in which R₄, R₅ and R₆ represent a hydrogen atom.

15. Method according to claim 1, in which a nucleolipid compound of formula (I) is used, selected from:
Thymidine 3′-(1,2-dipalmitoyl-sn-glycero-3-phosphate;
(N-5′-(2′,3′-dioleoyl)uridine-N′,N′,N′-trimethylammonium tosylate).

16. Method according to claim 1, in which the separation step is carried out by decantation, centrifugation, filtration or mechanical wiping.

17. Method according to claim 1, in which the micropollutant is a medicament, a derivative of a medicament, a metabolite of a medicament, or a compound or a substance that is carcinogenic, mutagenic and/or reprotoxic (CMR) or a derivative or a metabolite thereof.

18. Method according to claim 1, in which the micropollutant is selected from ofloxacin, la ciprofloxacin, erythromycin, diclofenac, propranolol, metoprolol, carbamazepine, fluoxetine, dichlorvos, caffeine, ethinylestradiol, diuron, isoproturon, alachlor, aclonifen, chlorfenvinphos, quinoxifen, cyclophosphamide, doxorubicin, a taxane such as paclitaxel or docetaxel, a platinum derivative or 5-fluoracil.

19. Method according to claim 1, in which said surface is a surface based on glass, polymer, silicone or metal.

20. Use of at least one compound of formula (I) as defined in claim 1 for the decontamination of an aqueous liquid medium containing at least one micropollutant in molecular form or a surface contaminated with at least one micropollutant.
